(19) United States
(12) Patent Application Publication
(10) Pub. No.: US 2025/0205800 A1
(43) Pub. Date: Jun. 26, 2025

(54) FORCED FORMING APPARATUS FOR A PLURALITY OF WELDS IN NARROW SPACE

(71) Applicants: CHINA CONSTRUCTION SCIENCE AND INDUSTRY CORPORATION LTD., Shenzhen (CN); NRG INTELLIGENT WELDING EQUIPMENT CO., LTD., Wuhan (CN)

(72) Inventors: Renge LI, Shenzhen (CN); Yongqiang QIAO, Shenzhen (CN); Fuju ZHANG, Shenzhen (CN); Qingnian WEN, Shenzhen (CN); Yufei WANG, Shenzhen (CN); Zhiyu LI, Shenzhen (CN)

(73) Assignees: CHINA CONSTRUCTION SCIENCE AND INDUSTRY CORPORATION LTD., Shenzhen (CN); NRG INTELLIGENT WELDING EQUIPMENT CO., LTD., Wuhan (CN)

(21) Appl. No.: 18/770,163

(22) Filed: Jul. 11, 2024

(30) Foreign Application Priority Data
Dec. 26, 2023 (CN) 202311818552.9

(51) Int. Cl. B23K 9/02; B23K 9/028; B23K 9/23

(52) U.S. Cl. CPC B23K 9/0213; B23K 9/0282; B23K 9/23

(57) ABSTRACT

The present disclosure provides a forced forming apparatus for a plurality of welds in a narrow space, belonging to the field of welding technology, and the apparatus includes a plurality of first backing members arranged adjacent to one another, and second backing member group structures configured to interconnect every two adjacent first backing members; each of the second backing member group structures is used for adjusting a distance between two adjacent first backing members; and a frame enclosed by the first backing members and the second backing member group structures is configured to be clamped on back sides of welds of a workpiece to be welded; and the first backing members and the second backing member group structures are both provided with forming arced faces, and the forming arced faces are arranged opposite to the welds of the workpiece to be welded. According to the forced forming apparatus for a plurality of welds in a narrow space provided by the present disclosure, the distance is variable so that the frame can be clamped on the back sides of the welds. The formed frame simultaneously meets the forced forming requirements of the narrow space and the plurality of welds. The plurality of welds share a set of forced forming apparatus. The installation is simple and the welding efficiency is further improved.

### TECHNICAL FIELD

The present disclosure relates to the field of welding technology, and more particularly to a forced forming apparatus for a plurality of welds in a narrow space.

### BACKGROUND

The root pass forming technology is an important key technology in all welding connection methods, and the reason is that the quality of a root pass directly determines the final acceptance quality of a weld to a large extent. There are two forming methods of the root pass, i.e., free forming and forced forming. In high-energy density welding with precise welding groove size processing and precise assembly, such as electron beam welding and laser welding, free forming is usually used. However, in the field of arc welding technology, which is widely used in engineering, because the size of a weldment is often very large, the precise processing of the welding groove size and the precise assembly of welds often fail to meet the requirements under actual production conditions, that is, under actual arc welding production conditions, except for a very small number of special production conditions of welding groove size precision processing and precision assembly, there are a small number of free forming applications, most conditions adopt two technologies to ensure the quality of the root pass: one is to add back root cleaning and back forming welding after front free forming welding, and the other is to use the forced forming technology on back sides during front welding.

For example, Chinese patent document CN103586622A discloses a circulating water-cooled backing apparatus for welding, which is arranged on a back side of a weld, and uses a water-cooled backing to force formation of the back weld.

However, in the case where there are a plurality of welds in a narrow space, as shown in FIG. 1, there are a plurality of welds to be welded in the narrow space, if the back sides of the welds are forcibly formed by using the conventional backing apparatus, it is necessary to sequentially fix backing members in the narrow space, and the installation process is more cumbersome.

### SUMMARY OF THE INVENTION

Therefore, the technical problem to be solved by the present disclosure is to overcome the defect in the prior art that the installation process is cumbersome when a space is narrow and a plurality of welds are forcibly formed by backing members, thereby providing a forced forming apparatus for a plurality of welds in a narrow space.

In order to solve the above technical problem, the present disclosure provides a forced forming apparatus for a plurality of welds in a narrow space, including:
a plurality of first backing members, arranged adjacent to one another; and
second backing member group structures configured to interconnect every two adjacent first backing members, each of the second backing member group structures being used for adjusting a distance between two adjacent first backing members, a frame enclosed by the first backing members and the second backing member group structures being configured to be clamped on back sides of welds of a workpiece to be welded; wherein
the first backing members and the second backing member group structures are both provided with forming arced faces, and the forming arced faces are arranged opposite to the welds of the workpiece to be welded.

Optionally, each of the second backing member group structures includes:
a plurality of second backing members, and the distance between two adjacent first backing members can be adjusted by adjusting a gap between adjacent second backing members.

Optionally, a total amount of expansion of one of the second backing member group structures is S, a length of one weld corresponding to said one of the second backing member group structures is M, the gap between adjacent second backing members is G, a length of each second backing member is L, and L is calculated as:

G=0.5 mm, L=(M−S)÷(2S+1);

G=1.0 mm, L=(M−S)÷(S+1).

Optionally, each of the second backing member group structures further includes:
a connection shaft on which the plurality of second backing members are sleeved, the second backing members being movable along the connection shaft; and
elastic members through which adjacent second backing members are connected to one another, each of the elastic members having an elastic force that allows two adjacent second backing members to move toward each other or away from each other.

Optionally, the forced forming apparatus for a plurality of welds in a narrow space further includes:
a plurality of adjustment assemblies, wherein every two adjacent first backing members have at least one of the adjustment assemblies arranged therebetween, and each of the adjustment assemblies is used for adjusting a distance between two adjacent first backing members.

Optionally, the forced forming apparatus for a plurality of welds in a narrow space further includes: guide assemblies, wherein each of the guide assemblies includes:
a first connection member connected with one of two adjacent first backing members, the first connection member being provided with a guide rod, the guide rod being parallel to a corresponding second backing member group structure; and
a second connection member connected with the other of the two adjacent first backing members, the second connection member being provided with a guide slot in cooperation with the guide rod.

Optionally, a first cooling pipeline is arranged in each of the first backing members and a second cooling pipeline is arranged in each of the second backing member group structures, the first cooling pipeline and the second cooling pipeline being connected in series in sequence, the second cooling pipeline being a telescopic pipeline.

Optionally, the first cooling pipeline and the second cooling pipeline each include an inlet water path and a return water path which are mutually connected, the inlet water path being close to a corresponding weld of the workpiece to be welded and the return water path being away from the corresponding weld of the workpiece to be welded.

Optionally, the second cooling pipeline includes:
at least one first pipe; and
at least one second pipe, one end of the second pipe being slidably sleeved on one end of the first pipe.

Optionally, the first backing members and the second backing member group structures are both made of copper.

The technical solution of the present disclosure has the following advantages:

1. The forced forming apparatus for a plurality of welds in a narrow space provided by the present disclosure includes the plurality of the first backing members arranged adjacent to one another, and the second backing member group structures configured to interconnect every two adjacent first backing members; each of the second backing member group structures are used for adjusting the distance between two adjacent first backing members, and the frame enclosed by the first backing members and the second backing member group structures is configured to be clamped on the back sides of the welds of the workpiece to be welded; and the first backing members and the second backing member group structures are both provided with forming arced faces, and the forming arced faces are arranged opposite to the welds of the workpiece to be welded. The distance between the adjacent first backing members is adjusted by the second backing member group structures, and the distance is variable so that the frame can be clamped on the back sides of the welds. The formed frame simultaneously meets the forced forming requirements of the narrow space and the plurality of welds. The plurality of welds share a set of forced forming apparatus. The installation is simple and the welding efficiency is further improved.

2. According to the forced forming apparatus for a plurality of welds in a narrow space provided by the present disclosure, each of the second backing member group structures includes the plurality of second backing members, and the distance between the two adjacent first backing members can be adjusted by adjusting the gap between the adjacent second backing members. The gap between the adjacent second backing members is controlled, so that the welding quality is not affected, and the whole set of forced forming apparatus can be easily installed in a welding structure, and can be conveniently removed from the workpiece to be welded after the welding is completed.

3. According to the forced forming apparatus for a plurality of welds in a narrow space provided by the present disclosure, according to the set gap between the adjacent second backing members, the total amount of expansion and the length of one weld corresponding to one of the second backing member group structures, the length of each second backing member is calculated, and a reasonable length of the second backing member not only ensures the requirement of the gap, avoids welding molten metal flowing out from the gap to affect the welding quality, but also realizes the set total amount of expansion, which is convenient for the installation and removal of the frame in a narrow space.

4. According to the forced forming apparatus for a plurality of welds in a narrow space provided by the present disclosure, each of the second backing member group structures further includes the connection shaft and elastic members, the plurality of second backing members are sleeved on the connection shaft, the second backing members are movable along the connection shaft, and the moving direction of the second backing members is defined, so that the second backing members are always close to the welds when moving, and the quality of the welds is guaranteed. The adjacent second backing members are connected by one elastic member, and each of the elastic members has an elastic force that allows two adjacent second backing members to move toward each other or away from each other. After the second backing member group structures are stretched out, owning to the elastic members, the gap between the second backing members is automatically kept equal, thus avoiding the situation that individual gaps are large and exceed the set gap after the gaps are unequal, and the welding molten metal leaks from the gap. There is no need to set additional limiting parts. The structure is simple and the adjustment is convenient.

5. The forced forming apparatus for a plurality of welds in a narrow space provided by the present disclosure further includes the plurality of adjustment assemblies, wherein every two adjacent first backing members have at least one of the adjustment assemblies arranged therebetween, and each of the adjustment assemblies is used for adjusting the distance between the two adjacent first backing members. The plurality of adjusting assemblies are provided so that a distance between adjacent first backing members of any group can be adjusted, ensuring a change in size in all directions of the frame, and smooth completion of assembly and disassembly.

6. The forced forming apparatus for a plurality of welds in a narrow space provided by the present disclosure further includes the guide assemblies, wherein each of the guide assemblies include the first connection member and the second connection member, and the first connection members and the second connection members are connected by guide rods and guide slots, so that the movement process between the adjacent first backing members is more stable and accurate.

7. According to the forced forming apparatus for a plurality of welds in a narrow space provided by the present disclosure, a first cooling pipeline is arranged in each of the first backing members and a second cooling pipeline is arranged in each of the second backing member group structures, the first cooling pipeline and the second cooling pipeline being connected in series in sequence. During the welding process, cooling water is provided in the cooling pipelines to flow, it is ensured that the formation of the back sides of the welds is beautiful and smooth, and the generation of atomic bonding between weld metal and a water-cooled backing is reliably prevented, and the backing members can be repeatedly used and have a long life. Wherein, each second cooling pipeline is a telescopic pipeline adapted to the corresponding second backing member group structure that is variable, and a change in the length of each of the second backing member group structures does not affect the circulation of the cooling water.

8. According to the forced forming apparatus for a plurality of welds in a narrow space provided by the present disclosure, the first cooling pipeline and the second cooling pipeline each include an inlet water path and a return water path which are mutually connected, the setting of double-path circulating cooling water further ensures the cooling effect. The inlet water path is close to the corresponding weld of the workpiece to be welded, and the weld is fully cooled.

9. According to the forced forming apparatus for a plurality of welds in a narrow space provided by the present disclosure, the second cooling pipeline includes at least one first pipe and at least one second pipe, one end of the second pipe being slidably sleeved on one end of the first pipe. Through the mutual sleeving of the first pipe and the second pipe, the second cooling pipeline can be stretched and retracted, and the first pipe and the second pipe can be moved following the movement between the adjacent backing members. The expansion method is simple and convenient.

10. According to the forced forming apparatus for a plurality of welds in a narrow space provided by the present disclosure, the first backing members and the second backing member group structures are both made of copper which has relatively weak metal reactivity, and generally does not undergo a chemical reaction at a low temperature to prevent a reaction between the backing members and the workpiece to be welded.

### BRIEF DESCRIPTION OF THE DRAWINGS

To illustrate the technical solutions in the specific embodiments of the present disclosure or in the prior art more clearly, the accompanying drawings required for use in the detailed description or the prior art will be briefly described below, and it is obvious that the accompanying drawings in the following description are some embodiments of the present disclosure, and other drawings can be obtained from these drawings for those of ordinary skill in the art without paying inventive steps.

FIG. 1 is a schematic diagram showing a specific structure of a workpiece to be welded having a narrow space and a plurality of welds;

FIG. 2 is a structural schematic diagram of a specific embodiment of a forced forming apparatus for a plurality of welds in a narrow space according to an embodiment of the present disclosure;

FIG. 3 is a schematic top view of a structure of a first backing member of FIG. 2 in a workpiece to be welded;

FIG. 4 is a structural schematic diagram of one of the second backing member group structures of FIG. 2;

FIG. 5 is another structural schematic diagram of a second cooling pipeline in each of the second backing member group structures of FIG. 2;

FIG. 6 is a schematic diagram of a connection structure of the cooling pipelines of FIG. 2 between mutually perpendicular backing members;

FIG. 7 is a schematic diagram of cooling water circulation in FIG. 2;

FIG. 8 is a schematic top view of a structure of an adjustment assembly of FIG. 2;

FIG. 9 is a structural schematic front view of FIG. 8; and

FIG. 10 is a schematic front view of a structure of another adjustment assembly of FIG. 2.

### DESCRIPTION OF REFERENCE NUMERALS

1, first backing member; 2, second backing member group structure; 3, workpiece to be welded; 4, forming arced face; 5, second backing member; 6, guide rod; 7, connection shaft; 8, elastic member; 9, adjustment assembly; 10, guide assembly; 11, first connection member; 12, second connection member; 13, first cooling pipeline; 14, second cooling pipeline; 15, first pipe; 16, second pipe; 17, guide slot; 18, cam member; 19, moving rod; 20, mounting frame; 21, poke rod; 22, clamping member; 23, clamping slot; 24, push rod; 25, sliding rod, 26, sliding slot; 27, operating rod; 28, stopper; 29, pipeline; 30, cooling channel; and 31, adapter pipe.

### DETAILED DESCRIPTION

The technical solutions of the present disclosure will be clearly and completely described below with reference to the accompanying drawings, and it is obvious that the described embodiments are some embodiments of the present disclosure, but not all embodiments. Based on the embodiments in the present disclosure, all other embodiments obtained by those of ordinary skill in the art without making inventive labor belong to the scope of protection of the present disclosure.

In the description of the disclosure, it should be noted that, the terms “center”, “upper”, “lower”, “left”, “right”, “vertical”, “horizontal”, “inner”, “outer” and the like indicate an orientation or positional relationship based on the orientation or positional relationship shown in the drawings, are only for ease of description of the disclosure and for simplicity of description, and are not intended to indicate or imply that the device or element referred to must have a particular orientation, be constructed and operate in a particular orientation, and therefore should not be construed as limiting the disclosure. Moreover, the terms “first”, “second”, and “third” are used for descriptive purposes only and are not to be construed as indicating or implying relative importance.

In the description of the present disclosure, it should be noted that, unless expressly specified and limited otherwise, the terms “installed”, “connected”, and “connection” are to be understood broadly, e.g., the connection can be fixed connection, detachable connection, or integral connection; the connection can be mechanical or electrical connection; the connection may be a direct connection or an indirect connection through an intermediate medium, and may be a communication between two elements. The specific meanings of the above terms in the present disclosure can be understood by those of ordinary skill in the art based on specific circumstances.

In addition, the technical features involved in the different embodiments of the present disclosure described below may be combined with each other as long as they do not conflict with each other.

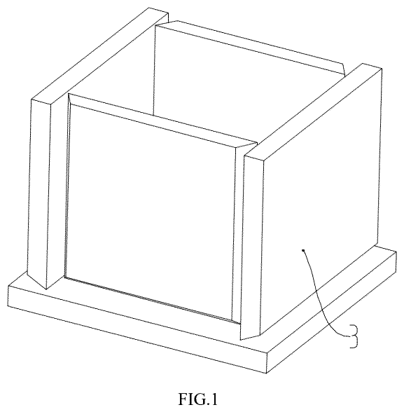

As shown in FIG. 1, there is a workpiece to be welded with a narrow space and a plurality of welds, the workpiece to be welded 3 is of a box structure with an opening at a top. The workpiece to be welded 3 includes a bottom plate and four side plates sequentially arranged on the bottom plate. There are transverse welds between the four side plates and the bottom plate, and longitudinal welds between adjacent side plates. There are a total of eight welds. Before welding, the side plates need to be fixed from the outside to avoid their movement, and then the forced apparatus is used for internal clamping.

A forced forming apparatus for a plurality of welds in a narrow space provided by this embodiment meets the forced forming requirements of a narrow space and a plurality of welds at the same time, the installation is simple, and the welding efficiency is further improved. The apparatus can not only be used for narrow gap/ultra-narrow gap MAG/MIG welding processes, but also be widely used for all traditional arc welding processes.

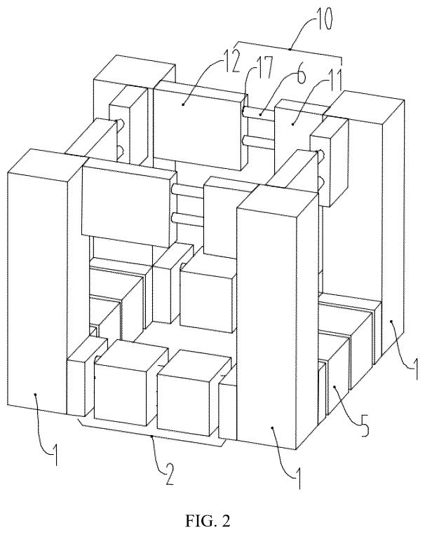

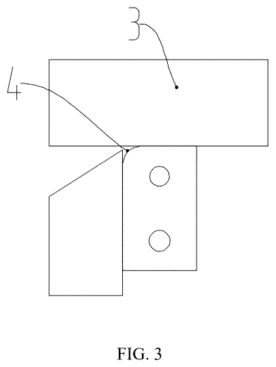

As shown in FIGS. 2 to 3, which show one specific embodiment of the forced forming apparatus for a plurality of welds in a narrow space provided by this embodiment, the apparatus includes first backing members 1 arranged adjacently to one another, and second backing member group structures 2 configured to interconnect every two adjacent first backing members 1, each of the second backing member group structures 2 being used for adjusting a distance between two adjacent first backing members 1, a frame enclosed by the first backing members 1 and the second backing member group structures 2 being configured to be clamped on back sides of welds of a workpiece to be welded 3; the first backing members 1 and the second backing member group structures 2 are bath provided with forming arced faces 4, and the forming arced faces 4 are arranged opposite to the welds of the workpiece to be welded 3. The distance between the adjacent first backing members 1 is adjusted by the second backing member group structures 2, and the distance is variable so that the frame can be clamped on the back sides of the welds. The formed frame simultaneously meets the forced forming requirements of the narrow space and the plurality of welds. The plurality of welds share a set of forced forming apparatus. The installation is simple and the welding efficiency is further improved.

In particular, the backing members of the first backing members 1 and the second backing member group structures 2 are rectangular in cross-section, the arrangement of a rectangular shape is more stable, for the workpiece to be welded 3 shown in FIG. 1, four first backing members 1 and four second backing member group structures 2 are provided, and are connected in sequence to form a frame structure. The first backing members 1 are used to form longitudinal welds, and the second backing member group structures 2 are used to form transverse welds. The forming arced faces 4 are disposed at positions in close proximity to weld roots on the first backing members 1 and the second backing member group structures 2. Each forming arced face 4 is determined by an assembly gap at the weld root and a radius of the arced face is directly related to the assembly gap. The larger the assembly gap, the larger the radius of the arced face. In one specific embodiment, the assembly gap at the weld root is 3 mm and the forming arced face 4 has a radius of 5 mm.

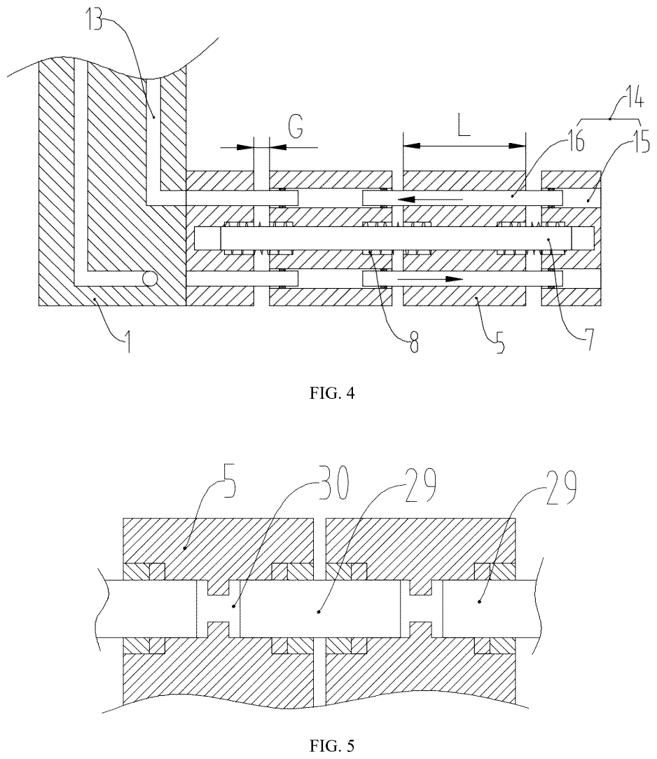

As shown in FIGS. 2 and 4, according to the forced forming apparatus for a plurality of welds in a narrow space provided by this embodiment, each of the second backing member group structures 2 includes a plurality of second backing members 5, and the distance between two adjacent first backing members 1 can be adjusted by adjusting a gap between adjacent second backing members 5. The gap between the adjacent second backing members 5 is controlled, so that the welding quality is not affected, and the whole set of forced forming apparatus can be easily installed in a welding structure, and can be conveniently removed from the workpiece to be welded 3 after the welding is completed.

In particular, the second backing members 5 at both ends in the second backing member group structures 2 are end backing members, the second backing member 5 between the two end backing members is an intermediate backing member, and there may be a fixed connection between the end backing members and the first backing members 1, and a movable connection between the end backing members and the intermediate backing member, and between adjacent intermediate backing members. Besides, there may be a movable connection between the end backing members and the first backing members.

According to the forced forming apparatus for a plurality of welds in a narrow space provided by this embodiment, a total amount of expansion of one of the second backing member group structures 2 is S, a length of one weld corresponding to said one of the second backing member group structures 2 is M, the gap between adjacent second backing members 5 is G, a length of each second backing member 5 is L, and L is calculated as:

$$G = 0.5 mm , L = ( M - S ) \div ( 2 S + 1 ) ;$$

$$G = 1. mm , L = ( M - S ) \div ( S + 1 ) .$$

The gap is typically in the range of 0.5 mm to 1.0 mm. The gap is chosen differently depending on a solution of welding metal to avoid the solution from flowing out of the gap. A reasonable length of the second backing member 5 not only ensures the requirement of the gap, avoids welding molten metal flowing out from the gap to affect the welding quality, but also realizes the set total amount of expansion, which is convenient for the installation and removal of the frame in a narrow space. When the length L of the second backing member 5, calculated according to the above formula, is a non-integer number, the lengths of the end backing members and the intermediate backing members are correspondingly adjusted so that the intermediate backing member is rounded and a non-integer portion falls at the end backing member. When the length M of the weld corresponding to one of the second backing member group structures 2 is small, the lengths of the end backing members can be made as short as possible and the length of the intermediate backing member can be made as long as possible.

In a specific embodiment, the length M of one transverse weld corresponding to one of the second backing member group structures 2 is 100 mm, the gap G between the adjacent second backing members is 1 mm, the total amount of expansion S is 5 mm, and the calculated Lis 15.5 mm. The lengths of the end backing members and the intermediate backing members can be reasonably adjusted, the length of the intermediate backing member can be selected to be 19 mm and the length of the end backing member can be selected to be 8.8 mm.

As shown in FIG. 4, according to the forced forming apparatus for a plurality of welds in a narrow space provided by this embodiment, each of the second backing member group structures 2 further includes a connection shaft 7 and elastic members 8, the plurality of second backing members 5 are sleeved on the connection shaft 7, and the second backing members 5 are movable along the connection shaft 7; and adjacent second backing members 5 are connected to one another by the elastic members 8 each having an elastic force that allows two adjacent second backing members 5 to move toward each other or away from each other.

The second backing members 5 are movable along the connection shaft 7 to define the direction of movement of the second backing members 5, so that the second backing members 5, when moving, are always close to the welds, and the weld quality is guaranteed. The adjacent second backing members 5 are connected by the elastic members 8, after the second backing member group structures 2 are stretched out, owning to the elastic members 8, the gap between the second backing members 5 is automatically kept equal, thus avoiding the situation that individual gaps are large and exceed the set gap after the gaps are unequal, and the welding molten metal leaks from the gap. There is no need to set additional limiting parts. The structure is simple and the adjustment is convenient.

In particular, the connection shaft 7 is parallel to the corresponding transverse weld, the connection shaft 7 is arranged in the middles of the second backing members 5, when the end backing members are fixedly connected with the first backing members 1, two ends of the connection shaft 7 are respectively arranged in the end backing members, a moving space of the connection shaft 7 after the corresponding second backing member group structure 2 is compressed is arranged in the end backing member, and after the second backing member group structures 2 are unfolded, the second backing members 5 are not detached from the corresponding connection shaft 7; a side wall of each of the second backing member group structures 2 is provided with an elastic member mounting hole, and the elastic members 8 are mounted in the elastic member mounting holes, so that after compression, the gap between the adjacent second backing members 5 can be zero; and the elastic members 8 are springs, and the size and specification of the plurality of elastic members 8 in each of the second backing member group structures 2 are the same to ensure the same gap after expansion.

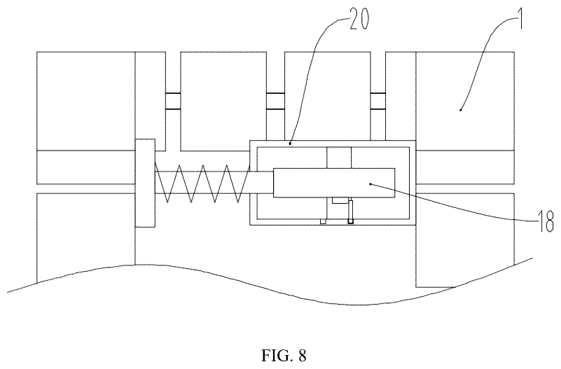

As shown in FIGS. 8 to 10, the forced forming apparatus for a plurality of welds in a narrow space provided by this embodiment further includes a plurality of adjusting assemblies 9, wherein every two adjacent first backing members 1 have at least one of the adjustment assemblies 9 arranged therebetween, and each of the adjustment assemblies 9 is used for adjusting a distance between two adjacent first backing members 1. The plurality of adjusting assemblies 9 are provided so that a distance between adjacent first backing members 1 of any group can be adjusted, ensuring a change in size in all directions of the frame, and smooth completion of assembly and disassembly.

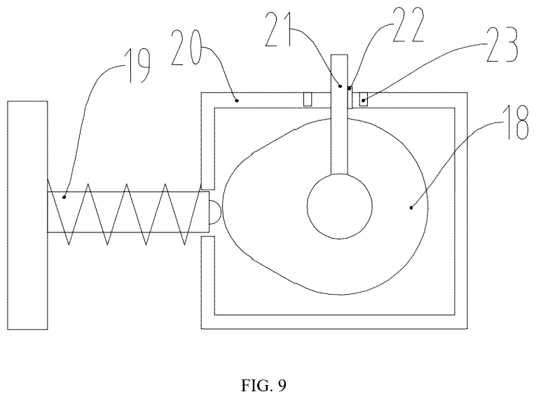

In particular, as shown in FIGS. 8 and 9, each of the adjusting assemblies 9 includes a cam member 18, a moving rod 19 and a mounting frame 20, the mounting frame 20 is fixedly connected with one of the first backing members 1, the cam member 18 is rotatably arranged in the mounting frame 20, a rotation shaft of the cam member 18 is fixedly connected with a poke rod 21, the moving rod 19 is fixedly mounted on one adjacent first backing member 1, a spring is sleeved on the moving rod 19, one end of the spring is connected with the mounting frame 20, the other end of the spring is connected with the moving rod 19, the spring has an elastic force that causes an end of the moving rod 19 to always abut against a rim of the cam member 18, by rotating the poke rod 21, the cam member 18 rotates, the moving rod 19 is pushed to move for the adjustment of the distance between two adjacent first backing members 1, and a clamping member 22 may be provided to be rotatably connected to the poke rod 21. A clamping slot 23 which is adapted to the clamping member 22 is disposed in the mounting frame 20. When the poke rod 21 is moved to a position where the gap between the second backing members 5 is zero or maximum two extreme positions, the clamping member 22 is clamped in the clamping slot 23, so that the poke rod 21 can be fixed to prevent the poke rod 21 from shaking.

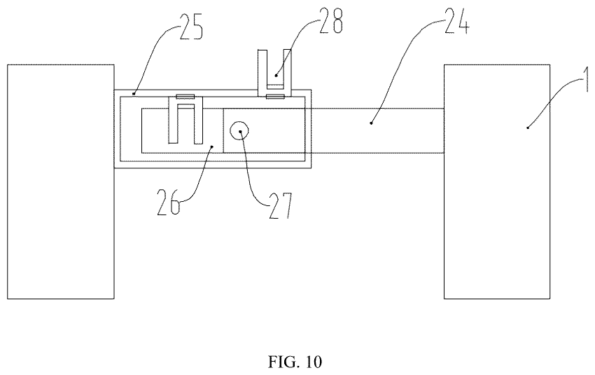

In addition, as an alternative embodiment, as shown in FIG. 10, each of the adjustment assemblies 9 may also be a push rod structure, including a push rod 24 and a sliding rod 25, the push rod 24 and the sliding rod 25 are respectively connected with the adjacent first backing members 1, the sliding rod 25 is provided with a sliding slot 26 in which the push rod 24 is slidably disposed, the push rod 24 is provided with an operating rod 27 which is pushed to move the push rod 24 in the sliding slot 26 to adjust the distance between two adjacent first backing members 1, and a stopper 28 is rotatably disposed at two extreme positions of the sliding slot 26 to fix the push rod 24 after position adjustment.

As shown in FIG. 2, the forced forming apparatus for a plurality of welds in a narrow space provided by this embodiment further includes guide assemblies 10. Each of the guide assemblies 10 includes a first connection member 11 and a second connection member 12, the first connection member is connected with one of two adjacent first backing members 1, the first connection member 11 being provided with a guide rod 6, the guide rod being parallel to a corresponding second backing member group structure 2. The second connection member 12 is connected with the other of the two adjacent first backing members 1, the second connection member 12 being provided with a guide slot 17 in cooperation with the guide rod 6. The guide rods 6 and the guide slots 17 are cooperatively connected so that the movement process between the adjacent first backing members is more stable and accurate. In addition, as an alternative embodiment, the first connection member 11 is provided with a guide slot and the second connection member 12 is provided with a guide rod, wherein the first connection member 11 and the second connection member 12 each have a rectangular structure in cross section and are made of aluminum alloy, a guide sleeve can be sleeved in the guide slot 17, the guide rod 6 is slidably inserted in the guide sleeve, and the guide rod 6 and the guide sleeve are made of a copper-zinc alloy.

As shown in FIGS. 4 and 7, according to the forced forming apparatus for a plurality of welds in a narrow space provided by this embodiment, a first cooling pipeline 13 is arranged in each of the first backing members 1 and a second cooling pipeline 14 is arranged in each of the second backing member group structures 2, the first cooling pipeline 13 and the second cooling pipeline 14 being connected in series in sequence, the second cooling pipeline 14 being a telescopic pipeline. During the welding process, cooling water is provided in the cooling pipelines to flow, it is ensured that the formation of the back sides of the welds is beautiful and smooth, and the generation of atomic bonding between weld metal and a water-cooled backing is reliably prevented, and the backing members can be repeatedly used and have a long life. Each second cooling pipeline 14 is a telescopic pipeline adapted to the corresponding second backing member group structure that is variable, and a change in the length of each of the second backing member group structures 2 does not affect the circulation of the cooling water.

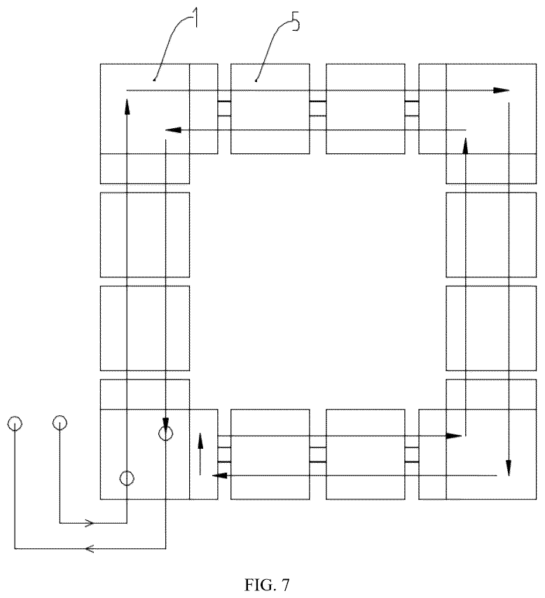

In particular, the first cooling pipeline 13 in the first backing member 1 is arranged in a vertical direction, the second cooling pipeline 14 in the second backing member 5 is arranged in a transverse direction, as shown in FIG. 6, and for a series connection of pipelines between the first backing member 1 and the second backing member 5 at 90° to each other, an adapter pipe 31 is arranged at a corner thereof, and the adapter pipe 31 is fixed in such a way that the adapter pipe 31 is inserted into the corresponding position in the backing member and then heated and brazed at a brazing joint at the adapter pipe. The telescopic pipeline is arranged such that there is a leak-free flow of inlet water and return water in all the backing members when the gap between the adjacent second backing members 5 is lost, and there is still a leak-free flow of inlet water and return water in all the backing members when the gap between the adjacent second backing members 5 is maintained.

As shown in FIG. 4, according to the forced forming apparatus for a plurality of welds in a narrow space provided by this embodiment, the first cooling pipeline 13 and the second cooling pipeline 14 each include an inlet water path and a return water path which are mutually connected, the inlet water path being close to a corresponding weld of the workpiece to be welded 3 and the return water path being away from the corresponding weld of the workpiece to be welded 3. The setting of double-path circulating cooling water further ensures the cooling effect, and the inlet water path is close to the corresponding weld of the workpiece to be welded 3, and the weld is fully cooled. Specifically, the inlet water paths in the cooling pipelines are connected in sequence, the return water paths are connected in sequence, i.e., cooling water introduced into the forced forming apparatus is fed into one of the inlet water paths, then passes through all of the inlet water paths in sequence, next passes through all the return water paths and is sent out to achieve an integrated cooling cycle. In order to make a series connection between the first backing member 1 and the second backing member 5, the inlet water path in each of the first backing members 1 may have a U-shaped structure, so that the cooling water in the inlet water path is sent up and then sent down to be connected to an inlet water path in a next second backing member 5.

As shown in FIG. 4, according to the forced forming apparatus for a plurality of welds in a narrow space provided by this embodiment, the second cooling pipeline 14 includes at least one first pipe 15 and at least one second pipe 16, one end of the second pipe 16 being slidably sleeved on one end of the first pipe 15. Through the mutual sleeving of the first pipe 15 and the second pipe 16, the second cooling pipeline 14 can be stretched and retracted, and the first pipe 15 and the second pipe 16 can be moved following the movement between the adjacent backing members. The stretching and retracting method is simple and convenient.

In particular, a sealing ring is disposed between the first pipe 15 and the second pipe 16, thus avoiding cooling water leakage when sliding, one way is, the first pipe 15 is fixedly arranged in one second backing member 5, the second pipe 16 is fixedly arranged in the adjacent second backing member 5, both ends of the first pipe 15 extend out of the second backing member 5, the length of the second pipe 16 is exactly the same as the length of the second backing member 5, an extension part of the first pipe 15 is arranged in the second pipe 16, and an end of the first pipe 15 is always in the second pipe 16 when the second backing members 5 are moved relative to each other.

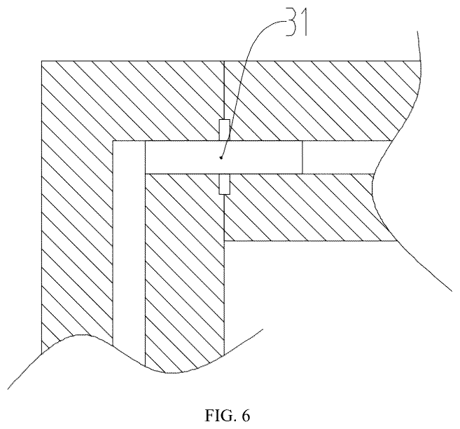

In addition, as an alternative embodiment, as shown in FIG. 5, the second cooling pipeline 14 may have other structures, for example, the second cooling pipeline 14 includes a plurality of pipelines 29, a cooling channel 30 is disposed in the second backing member 5, the pipelines 29 are slidably disposed in the cooling channel 30, sealing rings are disposed between the pipelines 29 and the cooling channel 30, and a space allowance for the movement of the pipelines 29 is disposed in the cooling channel 30, and the sealing rings can be compressed by sealing nuts.

According to the forced forming apparatus for a plurality of welds in a narrow space provided by this embodiment, the first backing members 1 and the second backing member group structures 2 are both made of copper, which has relatively weak metal reactivity and generally does not undergo a chemical reaction at a low temperature to avoid a reaction between the backing members and the workpiece to be welded. In addition, the first backing members 1 and the second backing member group structures 2 may also be made of silver, platinum, gold, or the like having a relatively weak reactivity.

A using process of the forced forming apparatus is as follows: in an initial state, the second backing member group structures 2 are contracted, the gap between adjacent second backing members 5 is zero, and the adjustment assemblies 9 fix this state; when welding is required, the whole apparatus is placed into the workpiece to be welded 3, then, the adjustment assemblies 9 are operated to expand the second backing member group structures 2 so that the set gap between the adjacent second backing members 5 is reached while the forming arced faces 4 correspond to the welds, cooling water is circulated in the backing members, and then the welding action is performed, and after the welding is completed, the adjusting assemblies 9 contract the second backing member group structures 2, and the whole apparatus is taken out.

Obviously, the above-described embodiments are merely examples for clarity of illustration and are not intended to limit the embodiments. For those of ordinary skill in the art, other different forms of changes or variations can also be made in light of the above description. All embodiments need not and cannot be exhausted here. However, obvious changes or variations derived therefrom are still within the scope of protection of the present disclosure.

1. A forced forming apparatus for a plurality of welds in a narrow space, comprising:
a plurality of first backing members (1) arranged adjacent to one another; and
second backing member group structures (2) configured to interconnect every two adjacent first backing members (1), each of the second backing member group structures (2) being used for adjusting a distance between two adjacent first backing members (1), a frame enclosed by the first backing members (1) and the second backing member group structures (2) being configured to be clamped on back sides of welds of a workpiece to be welded (3); wherein
the first backing members (1) and the second backing member group structures (2) are both provided with forming arced faces (4), and the forming arced faces (4) are arranged opposite to the welds of the workpiece to be welded (3).

2. The forced forming apparatus for a plurality of welds in a narrow space according to claim 1, wherein each of the second backing member group structures (2) comprises:
a plurality of second backing members (5), and the distance between two adjacent first backing members (1) can be adjusted by adjusting a gap between adjacent second backing members (5).

3. The forced forming apparatus for a plurality of welds in a narrow space according to claim 2, wherein a total amount of expansion of one of the second backing member group structures (2) is S, a length of one weld corresponding to said one of the second backing member group structures (2) is M, the gap between adjacent second backing members (5) is G, a length of each second backing member (5) is L, and L is calculated as:
G=0.5 mm, L=(M−S)÷(2S+1);
G=1.0 mm, L=(M−S)÷(S+1).

4. The forced forming apparatus for a plurality of welds in a narrow space according to claim 2, wherein each of the second backing member group structures (2) further comprises:
a connection shaft (7) on which the plurality of second backing members (5) are sleeved, the second backing members (5) being movable along the connection shaft (7); and
elastic members (8) through which adjacent second backing members (5) are connected to one another, each of the elastic members (8) having an elastic force that allows two adjacent second backing members (5) to move toward each other or away from each other.

5. The forced forming apparatus for a plurality of welds in a narrow space according to claim 1, further comprising:
a plurality of adjustment assemblies (9), wherein every two adjacent first backing members (1) have at least one of the adjustment assemblies (9) arranged therebetween, and each of the adjustment assemblies (9) is used for adjusting a distance between two adjacent first backing members (1).

6. The forced forming apparatus for a plurality of welds in a narrow space according to claim 1, further comprising guide assemblies (10), wherein each of the guide assemblies (10) comprises:
a first connection member (11) connected with one of two adjacent first backing members (1), the first connection member (11) being provided with a guide rod (6), the guide rod being parallel to a corresponding second backing member group structure (2); and
a second connection member (12) connected with the other of the two adjacent first backing members (1), the second connection member (12) being provided with a guide slot (17) in cooperation with the guide rod (6).

7. The forced forming apparatus for a plurality of welds in a narrow space according to claim 1, wherein a first cooling pipeline (13) is arranged in each of the first backing members (1) and a second cooling pipeline (14) is arranged in each of the second backing member group structures (2), the first cooling pipeline (13) and the second cooling pipeline (14) being connected in series in sequence, the second cooling pipeline (14) being a telescopic pipeline.

8. The forced forming apparatus for a plurality of welds in a narrow space according to claim 7, wherein the first cooling pipeline (13) and the second cooling pipeline (14) each comprise an inlet water path and a return water path which are mutually connected, the inlet water path being close to a corresponding weld of the workpiece to be welded (3) and the return water path being away from the corresponding weld of the workpiece to be welded (3).

9. The forced forming apparatus for a plurality of welds in a narrow space according to claim 7, wherein the second cooling pipeline (14) comprises:
at least one first pipe (15); and
at least one second pipe (16), one end of the second pipe (16) being slidably sleeved on one end of the first pipe (15).

10. The forced forming apparatus for a plurality of welds in a narrow space according to claim 1, wherein the first backing members (1) and the second backing member group structures (2) are both made of copper.
